(19) United States
(12) Patent Application Publication
(10) Pub. No.: US 2014/0152571 A1
(43) Pub. Date: Jun. 5, 2014

(54) ELECTRONIC DEVICE, CONTROL PROGRAM, AND CONTROL METHOD

(71) Applicant: Kabushiki Kaisha Toshiba, Tokyo (JP)

(72) Inventor: Kaoru Ishikawa, Fussa-shi (JP)

(73) Assignee: Kabushiki Kaisha Toshiba, Tokyo (JP)

(21) Appl. No.: 14/011,548

(22) Filed: Aug. 27, 2013

(30) Foreign Application Priority Data
Nov. 30, 2012 (JP) 2012-263661

(51) Int. Cl. G06F 3/041

(52) U.S. Cl. CPC G06F 3/041
USPC 345/168

(57) ABSTRACT

According to one embodiment, an electronic device includes: a display; a touch panel configured to detect a position on a display region of the display; a connection module configured to be connected to a device comprising a keyboard module, and a controller configured to deactivate a position detection function on the touch panel when the device is connected to the connection module and to activate the position detection function on the touch panel when the device is not connected to the connection module.

### CROSS-REFERENCE TO RELATED APPLICATIONS

This application is based upon and claims the benefit of priority from Japanese Patent Application No. 2012-263661, filed Nov. 30, 2012, the entire contents of which are incorporated herein by reference.

### FIELD

Embodiments described herein relate generally to an electronic device, a control program, and a control method.

### BACKGROUND

Conventionally disclosed have been various modes of electronic devices in accordance with expanding versatility required by users. For example, disclosed have been electronic devices comprising a keyboard module and a detachable touch panel.

In the conventional techniques, a position detection function of the touch panel remains activated regardless of whether the keyboard module is attached. Thus, the touch panel consumes electric power even when the touch panel is not in use.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating a configuration of a system according to a first embodiment that comprises an electronic device and an input device that is detachably attachable to the electronic device;

FIG. 2 is an exemplary block diagram illustrating an example of a hardware configuration of the electronic device in the first embodiment;

FIG. 3 is an exemplary conceptual view illustrating a touch panel that switches a position detection function based on attachment and detachment of the input device in the first embodiment;

FIG. 4 is an exemplary view illustrating an example of a setting screen to be displayed on a display in the first embodiment;

FIG. 5 is an exemplary flowchart illustrating procedures of processing when the input device is attached to and detached from the electronic device in the first embodiment;

FIG. 6 is an exemplary view illustrating a configuration of a system according to a second embodiment that comprises an electronic device, a docking device, and an input device;

FIG. 7 is an exemplary table illustrating a correspondence relation between activation of position detection on the touch panel and connection state in the second embodiment;

FIG. 8 is a conceptual exemplary view illustrating the touch panel whose position detection function is switched based on attachment and detachment of the input device and the docking device in the second embodiment; and

FIG. 9 is an exemplary flowchart illustrating procedures of processing when other devices are attached to and detached from the electronic device in the second embodiment.

### DETAILED DESCRIPTION

In general, according to one embodiment, an electronic device comprises: a display; a touch panel configured to detect a position on a display region of the display; a connection module configured to be connected to a device comprising a keyboard module, and a controller configured to deactivate a position detection function on the touch panel when the device is connected to the connection module and to activate the position detection function on the touch panel when the device is not connected to the connection module.

### First Embodiment

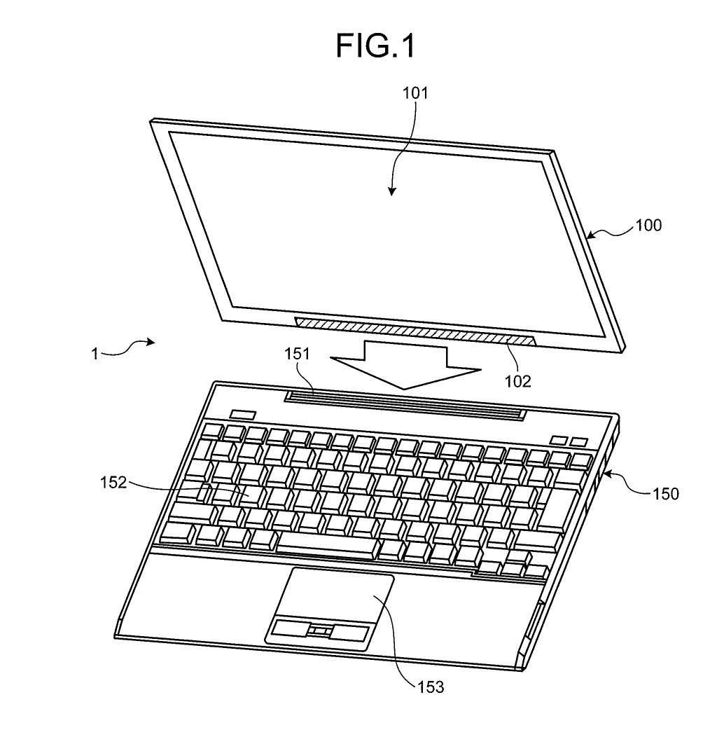

FIG. 1 is a view illustrating a configuration of a system 1 according to an embodiment that comprises an electronic device 100 and an input device 150. The input device 150 can be detachably attached to the electronic device 100. Even when the electronic device 100 illustrated in FIG. 1 is not connected to the input device 150, the electronic device 100 can be used as a mobile terminal (for example, tablet terminal). The electronic device 100 comprises a display device 101 and a connection module 102 for connection to the input device 150. The connection module 102 is an interface for connection to the input device 150.

The display device 101 incorporates a screen comprising a liquid crystal display (LCD) or an organic electro luminescence (EL). The screen of the LCD is located substantially at the center of the electronic device 100. A touch panel for detecting a position is provided on the display region of the display device 101.

The input device 150 illustrated in FIG. 1 comprises a connection module 151, a keyboard unit 152, and a touch pad 153. The connection module 151 is a module for connection to the electronic device 100.

When the electronic device 100 and the input device 150 are connected, they can be used as a laptop personal computer.

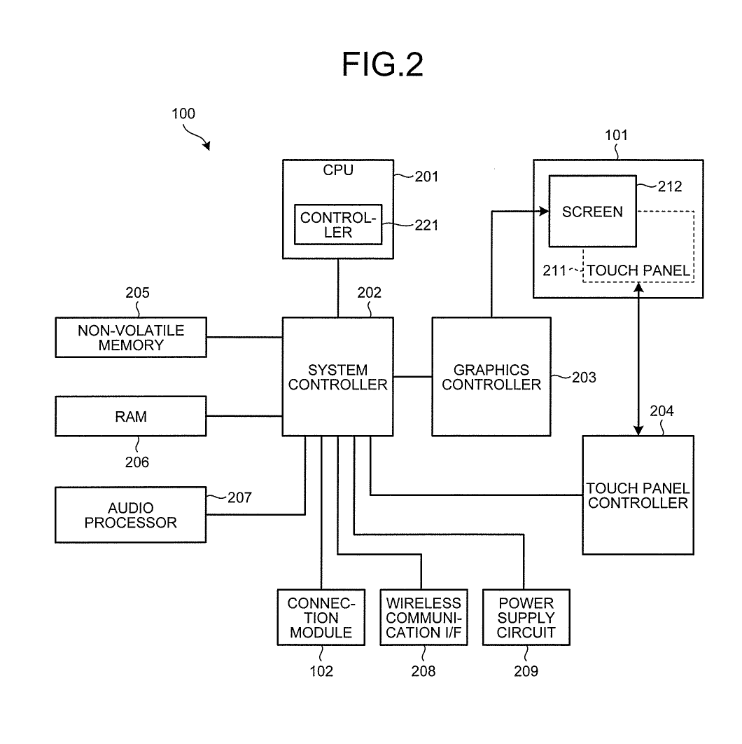

FIG. 2 is a block diagram illustrating an example of a hardware configuration of the electronic device 100 according to the first embodiment. As illustrated in FIG. 2, the electronic device 100 according to the first embodiment comprises the display device 101, a central processing unit (CPU) 201, a system controller 202, a graphics controller 203, a touch panel controller 204, a non-volatile memory 205, a random access memory (RAM) 206, an audio processor 207, the connection module 102, a wireless communication I/F 208, and a power supply circuit 209.

In the embodiment, the display device 101 comprises a touch panel 211, and a screen (display) 212 comprising a liquid crystal display (LCD) or an organic electro luminescent (EL) display. The touch panel 211 has a function of detecting positional coordinates on the surface thereof arranged on the screen 212, for example. The touch panel 211 can detect a position (touch position) on the display region of the screen 212 that has been touched by a finger of a user gripping the electronic device 100, for example. This function of the touch panel 211 allows the screen 212 to function as what is called a touch screen.

The CPU 201 is a processor that centrally controls operations of the electronic device 100 and controls each part of the electronic device 100 through the system controller 202. The CPU 201 executes an operating system loaded onto the RAM 206 from the non-volatile memory 205. The CPU 201 also executes a controller 221 on the operating system. The RAM 206 provides, as a main memory of the electronic device 100, a workspace for the CPU 201 to execute computer programs.

The system controller 202 also incorporates a memory controller that controls access to the non-volatile memory 205 and the RAM 206. The system controller 202 also has a function of communicating with the graphics controller 203. The system controller 202 also incorporates a microcomputer in which an embedded controller is integrated. The embedded controller controls the power supply circuit 209 for supplying electric power stored in a battery (not illustrated) comprised in the electronic device 100.

The graphics controller 203 is a display controller that controls display of an image on the screen 212 used as a display monitor of the electronic device 100. The touch panel controller 204 controls the touch panel 211 and acquires, from the touch panel 211, coordinate data indicating a touch position on the screen 212 that has been touched by the user.

The audio processor 207 performs audio processing such as digital conversion, noise removal, and echo cancelling on an audio signal input through a microphone (not illustrated) and outputs the processed audio signal to the CPU 201. The audio processor 207 also outputs an audio signal generated by performing audio processing such as audio synthesis thereon to a speaker (not illustrated) and outputs audio with the speaker under control of the CPU 201. The wireless communication I/F 208 is an interface that makes it possible to make wireless communication with an external communicable device.

The connection module 102 is a connection interface through which the electronic device 100 can be connected to the input device 150 comprising the keyboard unit 152. The system controller 202 has a function of receiving signals from the keyboard unit 152 and the touch pad 153 of the input device 150. This enables the user to perform various operations using the keyboard unit 152 and the touch pad 153 when the input device 150 is connected through the connection module 102. When the input device 150 is attached or detached, the system controller 202 detects the attachment or detachment of the input device 150 and notifies the CPU 201 of it.

The controller 221 of the CPU 201 is a computer program activated on the OS executed by the CPU 201 and performs control relating to the touch panel 211 in response to the notification of the attachment or detachment of the input device 150 from the system controller 202.

The controller 221 according to the embodiment deactivates the position detection on the touch panel 211 when having received notification indicating that the input device 150 is connected to the connection module 102. In contrast, the controller 221 activates the position detection function on the touch panel 211 when having received notification indicating that the input device 150 is not connected to the connection module 102.

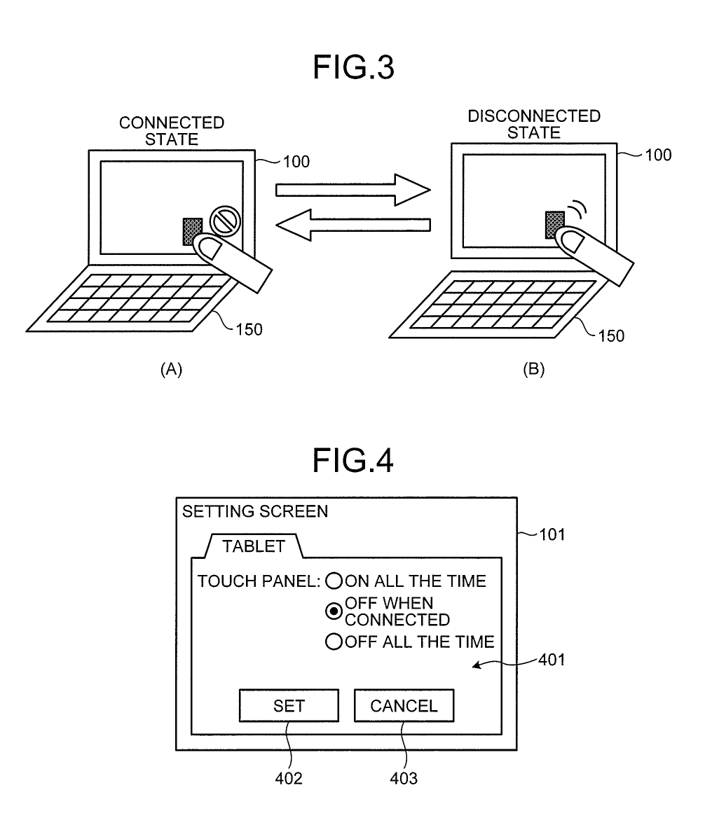

FIG. 3 is a conceptual view illustrating the touch panel 211 whose position detection function is switched based on the attachment and detachment of the input device 150. As illustrated in FIG. 3(A), when the input device 150 and the electronic device 100 are connected, the user can perform operations through the keyboard unit 152 and the touch pad 153 provided on the input device 150. For this reason, the controller 221 deactivates the position detection function of the touch panel 211.

In contrast, as illustrated in FIG. 3(B), when the input device 150 and the electronic device 100 are disconnected, the controller 221 activates the position detection function of the touch panel 211. Thus, the user can perform operations using the touch panel 211 even when the electronic device 100 is not connected to the input device 150.

In this manner, when the electronic device 100 is connected to the input device 150, the position detection function of the touch panel 211 is turned off so as to reduce electric power to be provided to the touch panel 211. This saves electric power.

The user can set on and off the switching of the position detection function of the touch panel 211 caused by the attachment and detachment of the input device 150. In the embodiment, the user can perform settings on a setting screen to be displayed on the display device 101 by performing particular operations.

FIG. 4 is a view illustrating an example of the setting screen to be displayed on the display device 101. On this setting screen 401 illustrated in FIG. 4, the user can make settings of the touch panel 211 on whether the position detection function of the touch panel 211 is activated when the input device 150 is connected.

In the example illustrated in FIG. 4, the controller 221 can receive any one of the options, “on all the time”, “off when connected”, and “off all the time”, as a setting on the touch panel 211 through the touch panel 211, the keyboard unit 152, or the touch pad 153.

The “on all the time” option is a setting with which the position detection on the touch panel 211 is performed all the time regardless of attachment and detachment of the input device 150. The “off when connected” option is a setting with which the position detection on the touch panel 211 stops working when the input device 150 is connected (not disconnected). The “off all the time” option is a setting with which the position detection on the touch panel 211 is inactive all the time regardless of attachment and detachment of the input device 150.

Thus, when a set button 402 is selected after the controller 221 has received any one of the above-mentioned options displayed on the setting screen, the controller 221 sets whether the position detection function on the touch panel 211 is activated when the input device 150 is connected. The setting can be cancelled with a cancel button 403.

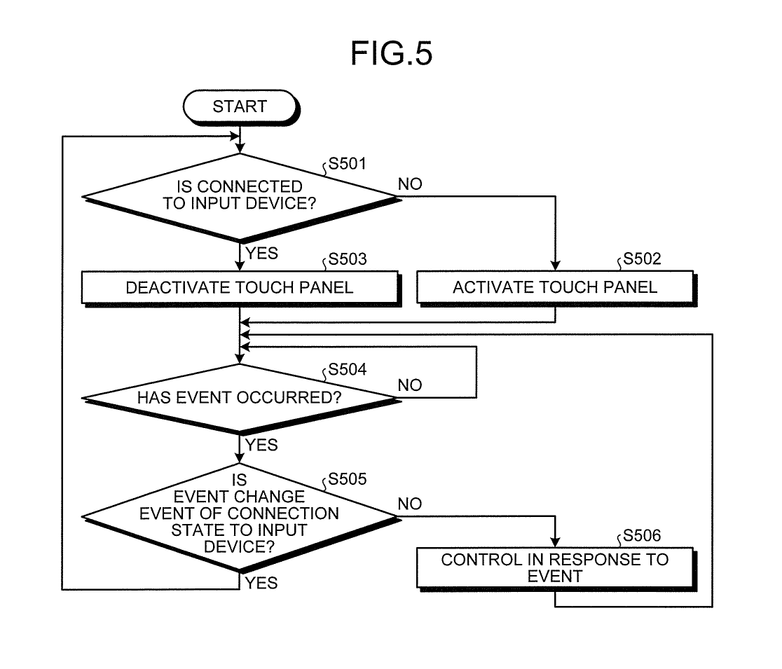

Next, described is processing at the time of the attachment and detachment performed between the electronic device 100 according to the embodiment and the input device 150. FIG. 5 is a flowchart illustrating procedures of the above-mentioned processing on the electronic device 100 according to the embodiment.

First, the controller 221 determines, based on notification from the system controller 202, whether the input device 150 is connected (S501) . When the controller 221 determines that the input device 150 is not connected (No at S501), the controller 221 activates the position detection function of the touch panel 211 (S502).

In contrast, when the controller 221 determines that the input device 150 is connected (Yes at S501), the controller 221 deactivates the position detection function of the touch panel 211 (S503).

Thereafter, the controller 221 determines whether an event has occurred (S504). When the controller 221 has determined that an event has not occurred (No at S504), the controller 221 repeats the detection of an event until an event occurs.

In contrast, when the controller 221 determines that an event has occurred (Yes at S504), the controller 221 determines whether the event is a change event of the connection state between the electronic device 100 and the input device 150 (S505). When the controller 221 determines that the event is not a change event (No at S505), the controller 221 performs relevant control in response to the event (S506), and then performs the processing from S504 again.

When the controller 221 determines that the event is a change event of the connection state between the electronic device 100 and the input device 150 (Yes at S505), the controller 221 starts to perform control from S501 again.

The above-mentioned processing procedures make it possible to perform switch control over activation and deactivation of the position detection function of the touch panel 211 based on the connection state to the input device 150.

### Second Embodiment

The first embodiment has described the example in which control is performed based on whether two devices of the electronic device 100 and the input device 150 are connected. The control is not limited to being performed based on the connection state between two devices and may be performed based on the connection states among equal to or more than three devices. The second embodiment describes an example in which control is switched based on the connection states among three devices.

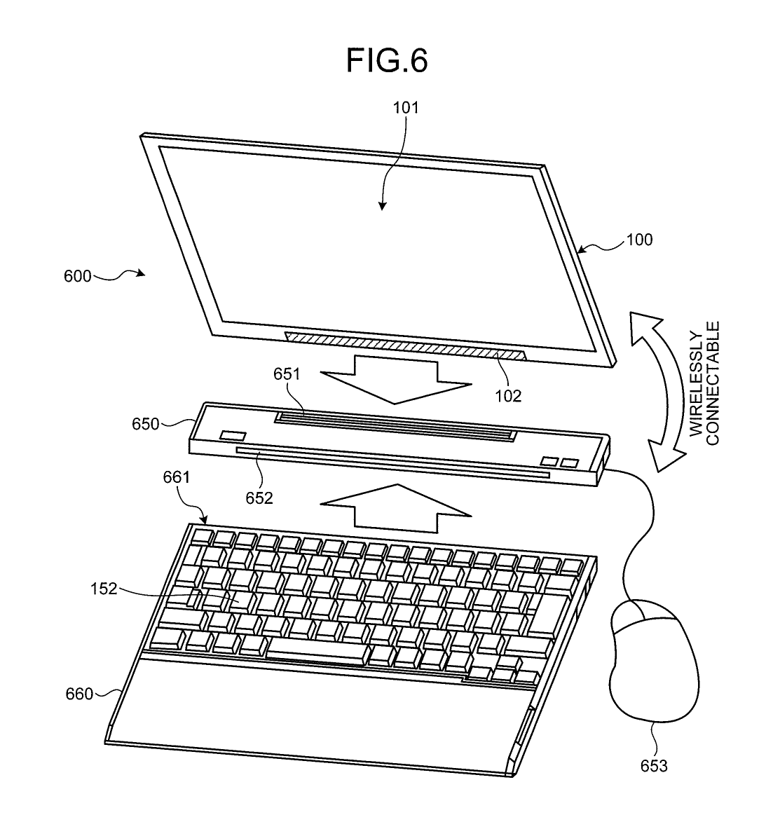

FIG. 6 is a view illustrating a configuration of a system 600 according to the second embodiment that comprises the electronic device 100, a docking device 650, and an input device 660. The docking device 650 can be detachably attached to the electronic device 100. The input device 660 can be detachably attached to the docking device 650. The electronic device 100 illustrated in FIG. 6 can be used as a mobile terminal even when not connected to the docking device 650. The configuration of the electronic device 100 is the same as that in the first embodiment and description thereof is omitted.

The docking device 650 comprises a first connection module 651 for connection to the electronic device 100 and a second connection module 652 for connection to the input device 660. The docking device 650 is connected to a pointing device 653.

The input device 660 comprises a connection module 661 and the keyboard unit 152. The input device 660 can communicate with an external device by wireless communication through an incorporated wireless communication I/F.

The input device 660 can be connected to the docking device 650 through the connection module 661 and can make wireless communication with the electronic device 100. When the wireless communication is made between the input device 660 and the electronic device 100, operations can be performed on the electronic device 100 using the keyboard unit 152 of the input device 660.

When the input device 660 and the electronic device 100 are connected wirelessly, in some cases a user has the electronic device 100 in hand whereas the input device 660 is placed at a position distanced from the user. In such a case, even if the input device 660 and the electronic device 100 are connected wirelessly, when the electronic device 100 is not connected to the docking device 650 physically, the controller 221 of the CPU 201 on the electronic device 100 according to the embodiment activates the position detection function of the touch panel 211.

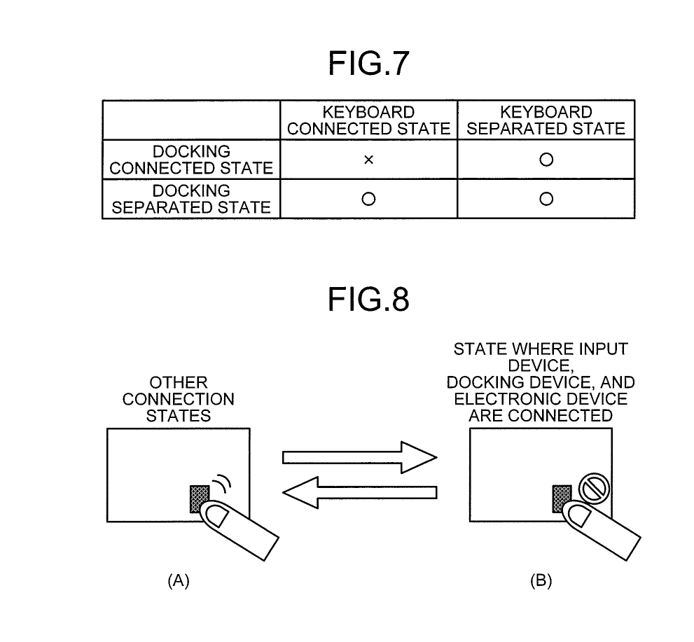

FIG. 7 is a table illustrating a correspondence relation between activation of the position detection on the touch panel 211 of the embodiment and the connection state. The position detection function is activated when “o” is marked in FIG. 7 and is deactivated when “x” is marked in FIG. 7.

The docking-connected state in FIG. 7 indicates a state where the docking device 650 and the electronic device 100 are connected physically through the connection modules (102 and 651). The docking-separated state in FIG. 7 indicates a state where the docking device 650 and the electronic device 100 are separated physically.

The keyboard-connected state in FIG. 7 indicates a state where it is detected that the electronic device 100 is connected to the input device 660. The keyboard-separated state in FIG. 7 indicates a state where it is detected that the electronic device 100 is not connected to the input device 660. To be more specific, the keyboard-connected state also includes the case where they are connected wirelessly in addition to the case where they are connected physically.

That is to say, when the electronic device 100 and the input device 660 are connected to each other and the docking device 650 and the electronic device 100 are connected to each other physically, the controller 221 according to the embodiment deactivates the position detection function of the touch panel 211. In any other states, the controller 221 activates the position detection function of the touch panel 211.

FIG. 8 is a conceptual view illustrating the touch panel 211 whose position detection function is switched based on attachment and detachment of the input device 660 and the docking device 650. As illustrated in FIG. 8(A), when at least one of the input device 660, the docking device 650, and the electronic device 100 is not connected, there is a possibility that inputting cannot be made through the input device 660 while the screen 212 is referred to, due to the arrangement relation between the electronic device 100 and the input device 660. For this reason, the controller 221 activates the position detection function of the touch panel 211.

As illustrated in FIG. 8(B), when all of the input device 660, the docking device 650, and the electronic device 100 are connected, inputting can be made through the input device 660 while the screen 212 of the electronic device 100 is referred to. For this reason, the controller 221 deactivates the position detection function of the touch panel 211.

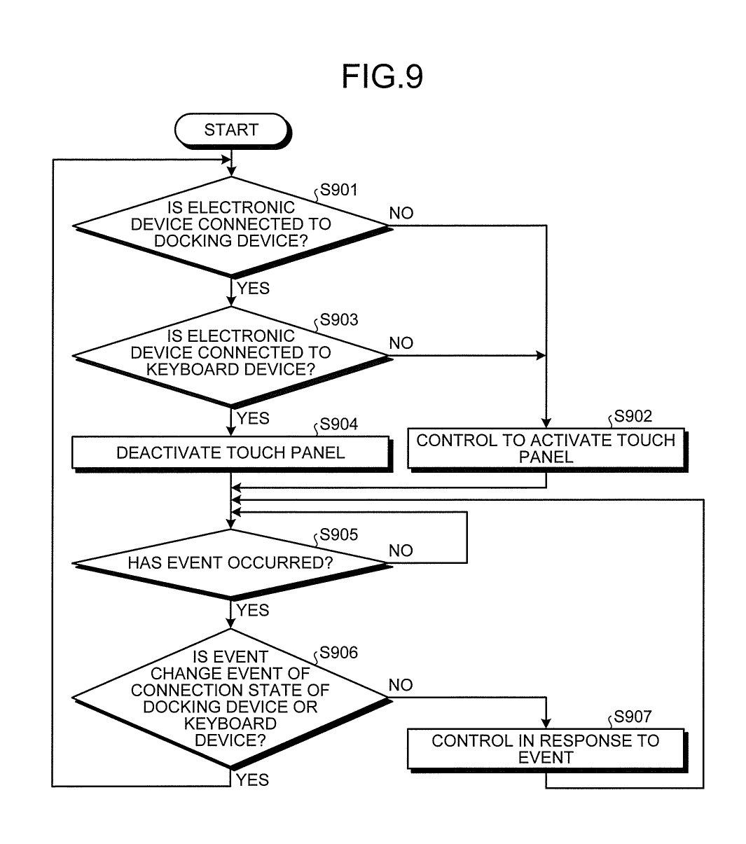

Next, described is processing performed when other devices (input device 660 and docking device 650) are attached to and detached from the electronic device 100 according to the embodiment. FIG. 9 is a flowchart illustrating procedures of the above-mentioned processing on the electronic device 100 according to the embodiment.

First, the controller 221 determines, based on notification from the system controller 202, whether the electronic device 100 is connected to the docking device 650 (S901). When the controller 221 determines that the electronic device 100 is not connected to the docking device 650 (No at S901), the controller 221 activates the position detection on the touch panel 211 (S902).

In contrast, when the controller 221 determines that the electronic device 100 is connected to the docking device 650 (Yes at S901), the controller 221 determines whether the electronic device 100 and the input device 660 are connected (S903). When the controller 221 determines that they are not connected (No at S903), the controller 221 activates the position detection on the touch panel 211 (S902).

In contrast, when the controller 221 determines that the electronic device 100 and the input device 660 are connected (Yes at S903), the controller 221 deactivates the position detection on the touch panel 211 (S904).

Thereafter, the controller 221 determines whether an event has occurred (S905). When the controller 221 determines that an event has not occurred (No at S905), the controller 221 repeats the detection of an event until an event occurs.

In contrast, when the controller 221 determines that an event has occurred (Yes at S905), the controller 221 determines whether the event is a change event of the connection state of the docking device 650 or the input device 660 (S906). When the controller 221 determines that the event is not a change event (No at S906), the controller 221 performs relevant control in response to the event (S907), and then performs the processing from S905 again.

When the controller 221 determines that the event is a change event of the connection state (Yes at S906), the controller 221 starts to perform the control from S901 again.

The above-mentioned processing procedures make it possible to perform switch control of the position detection function of the touch panel 211 based on the connection state to the input device 150.

With the above-mentioned embodiments, when the electronic device 100 is connected to a device comprising an interface capable of inputting, the position detection function of the touch panel 211 is deactivated so as to save electric power and reduce degradation of operability due to deactivation of the position detection function of the touch panel 211.

Control programs to be executed in the electronic device 100 in the above-mentioned embodiments are provided by being recorded in a computer-readable recording medium, such as a compact disc read only memory (CD-ROM), a flexible disk (FD), a CD recordable (CD-R), or a digital versatile disk (DVD), in an installable or executable file format.

The control programs to be executed in the electronic device 100 in the above-mentioned embodiments may be provided by being stored on a computer connected to network such as the Internet and being downloaded through the network. Alternatively, the control programs to be executed in the electronic device 100 in the above-mentioned embodiments may be provided or distributed through network such as the Internet.

The control programs in the above-mentioned embodiments may be provided by being incorporated in advance in a read-only memory (ROM) or the like.

The control programs to be executed in the electronic device 100 in the above-mentioned embodiments have a module configuration comprising the above-mentioned parts. As actual hardware, the CPU 201 loads the control programs from the above-mentioned storage medium and executes the programs, so that the above-mentioned parts are loaded and generated on a main storage device.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display;
a touch panel configured to detect a position on a display region of the display;
a connection module configured to be connected to a device comprising a keyboard module, and
a controller configured to deactivate a position detection function on the touch panel when the device is connected to the connection module and to activate the position detection function on the touch panel when the device is not connected to the connection module.

2. The electronic device of claim 1, wherein
the display is configured to display a setting screen for setting whether the position detection function on the touch panel is activated when the device is connected, and
the controller is configured to set whether the position detection function on the touch panel is activated when the device is connected in accordance with input onto the setting screen.

3. The electronic device of claim 1, wherein
the keyboard module is detachably attached to the device to which the connection module is connected, and
the controller is configured to deactivate the position detection function on the touch panel when the device is connected to the connection module and the keyboard module is connected to the device, and to activate the position detection function on the touch panel when the device is connected to the connection module and the keyboard module is not connected to the device.

4. A computer program product having a non-transitory computer readable medium including programmed instructions, wherein the instructions, when executed by a computer comprising a connection module to be connected to a device comprising a keyboard module, cause the computer to perform:
controlling to deactivate a position detection function on a touch panel comprised in the computer when the device is connected to the connection module and to activate the position detection function on the touch panel when the device is not connected to the connection module.

5. A control method that is executed in an electronic device comprising a display, a touch panel configured to detect a position on a display region of the display, and a connection module configured to be connected to a device comprising a keyboard module, the control method comprising:
controlling to deactivate a position detection function on the touch panel when the device is connected to the connection module and to activate the position detection function on the touch panel when the device is not connected to the connection module.
